(19) United States
(12) Patent Application Publication
(10) Pub. No.: US 2003/0171897 A1
(43) Pub. Date: Sep. 11, 2003

(54) Product performance integrated database apparatus and method

(76) Inventors: John Bieda, Lake Orion, MI (US); Charles A. Mierzwiak, Toledo, OH (US)

Correspondence Address: Andrew R. Basile, Young & Basile, P.C., Suite 624, 3001 West Big Beaver Road, Troy, MI, 48084, US

(21) Appl. No.: 10/085,292

(22) Filed: Feb. 28, 2002

(51) Int. Cl. G06F 15/00

(52) U.S. Cl. 702/185

(57) ABSTRACT

A product performance integrated database apparatus and method collects product performance data, determines the root cause of detected product failures and develops corrective action to correct the detected failures. The method determines an initial degree of risk of selected product failures by determining the severity of the effect of each failure and the frequency of occurrence of the effect of each failure. The severity of the effect and the frequency of occurrence are ranked with different ranking values. An initial risk assessment of each failure is the product of the ranked severity value and the selected ranked frequency of occurrence of the failure. Failures exceeding a threshold preliminary risk assessment are subject to the root cause or detected product failure analysis. Once a corrective action for the root cause of failure is determined, a final risk assessment for each corrective action is determined by the product of the initial risk assessment and a determined failure correction validation value.

### BACKGROUND

The development of a product involves numerous steps and contributions from many people over a long period of time from initial conception and design through development of prototypes, testing, final product design, the development of manufacturing processes for the product, the final product approval and then the manufacturing and delivery of the product to customers. While each product can be viewed as a new entity, frequently, companies who specialize in a particular product actually develop a new product which contains many features which can be carried over from prior products.

While it would be enviable to be able to develop a product without time and cost constraints in which each element of the product could be fully designed and completely tested at each stage of development; reality, however, imposes both time and cost constraints on any product development thereby requiring trade-offs in the amount of testing, and the available time and resources in terms of money, people, buildings, equipment, etc., which can be made available for a particular product development.

It is also very common for product development people, including engineers, designers, financial analysts, etc., to be working on several product development projects at one time. When one project is completed, such individuals immediately move on to the next product or project. This process has a tendency to isolate the people involved in the development of product from the warranty problems which arise after the product is introduced into the marketplace. Such warranty problems resulting from product defects in design, materials or combinations thereof, are directed back to appropriate individuals in the manufacturing company for problem detection and correction. Frequently, the individuals responsible for such warranty claims and correction are not the same individuals who were involved in initial product development and who would find the problems, causes and solutions to be of immense value when designing future products which may have similar features.

Despite the fact that large portions of the product development process are reduced to computer records, there usually exists no identifiable repository of manufacturing, engineering, and quality data which can be readily accessed and used for analysis and interpretation. Nor is there any linked databases which would allow for product performance traceability that is necessary for root cause investigations.

While failure mode effect and analysis (FMEA) is used by many companies as a design review technique to focus the development or products and processes on prioritized actions to reduce the risk of product field failures and to document those actions and the entire review process, frequently, there is inadequate FMEA content and utilization for a totally accurate risk assessment. Further, there is usually no updated, direct link of failure mode to current root cause and corrective action.

The current product development processes also lack any organized process to link the definition of engineering drawing characteristic or process control plan parameters to FMEA, root cause/corrective action, or supporting data. Such prior product development processes also lack any understanding of the quality cost elements (failure, appraisal, and prevent) that are attributable to the total cost of quality.

Further, there usually is no design or process specific lessons learned database to refer to for future product development.

Therefore, it is desirable to provide a product performance integrated database apparatus and methodology which has the following features:

1. A systematic link of product design and process information for root cause and risk assessment decision making.

2. Quality and reliability information traceability to all tasks and activities during the product development process.

3. Just in time FMEA development and generation of design/process guidelines.

4. Provides an understanding of the total cost of quality and its cost components.

5. Provides the basis for new product/process risk analysis by accumulating updated design/process specific lessons learned.

### SUMMARY

The present invention is a product performance integrated database apparatus and method which uniquely enables product performance data to be analyzed, placed in a prioritized initial risk assessment ranking based on initial failure effect risk so as to subject only high risk assessment failures to a root cause and effect analysis to develop a corrective action for the product failure. The corrective action is validated prior to a final risk assessment being made from the product of the initial risk assessment times a ranked validation value.

The present apparatus is embodied in a software program accessible through a telecommunication network. CPU based terminals provide prompts for acquiring, documenting and storing all product related performance data, risk assessment analysis, cause and effect analysis, and corrective actions.

The method of the present invention is used to determine product performance. The method comprises the steps of:

collecting product performance data;

determining the failure mode of detected product failures;

conducting a failure mode effect and analysis procedure to determine a degree of risk of a detected failure; and

developing corrective action to correct the detected failures.

The step of determining degree of risk includes the steps of determining the severity of the effect of each failure, and determining the frequency of occurrence of the effect of each failure. According to the method, the determined severity of effects of a plurality of different detected failures are ranked to generate a plurality of different severity ranking values. The frequency of occurrence of the plurality of different failures are also ranked in a ranked frequency of occurrence values.

The method includes the step of determining a preliminary risk assessment of each failure as a multiplied product of the ranked severity value and the ranked frequency of occurrence value. The preliminary risk assessment is compared with the threshold to determine high risk assessments suitable for a root cause and effect analysis. The analysis determines the root cause of the detected product failure.

The method and apparatus also include means and a process step for determining the cost of quality assessment. The total cost of quality assessment is determined by the sum of prevention costs, appraisal costs and failure costs.

The product performance integrated database apparatus and method of the present invention affords many advantages over previously devised product development processes. The present method provides a linking of product design and process information for use in root cause and risk assessment decision making. All quality and reliability information is traceable to all tasks and activities during the product development process.

The present method and apparatus also provides an understanding of the total cost of quality as well as the quality cost components. These costs as well as the stored lessons learned from each complete product development are stored for future use. This simplifies future product development programs by enabling quality issues to be shifted to the design and process development stage rather than later in the product prototype development or field use stages.

### BRIEF DESCRIPTION OF THE DRAWING

The various features, advantages and other uses of the present invention will become more apparent by referring to the following detailed description and drawing in which:

FIG. 1 is a block diagram of the product performance integrated database apparatus and method of the present invention;

FIG. 2 is a block diagram of the input database failure flow structure;

FIGS. 3A-3F are Pareto failure mode charts;

FIGS. 4A-4D are flow diagrams showing the sequence of the operation of the apparatus and method of the present invention;

FIG. 5 is a block diagram of the main sections of the FMEA risk assessment apparatus and method of the present invention;

FIGS. 6A, 6B and 6C are pictorial spreadsheet representations of the operation of the FMEA portion of the present invention;

FIGS. 7A and 7B are pictorial spreadsheet representations of the PDCA portion of the present invention;

FIG. 8 is a fishbone chart used in the PDCA portion of the invention shown in FIGS. 7A and 7B; and

FIG. 9 is a pictorial representation of a computer apparatus used to implement the present invention.

### DETAILED DESCRIPTION

The present product performance integrated database apparatus and method can be implemented via a suitable computer based local or wide area network or combinations thereof The plurality of computer based workstations 7 or PC's can access the product performance databases in memory 8 under program control to review, input, calculate and/or provide notifications as necessary to a central server or workstation containing such databases, processing units, memory, etc. Any suitable communication network 9 can be employed as part of the present apparatus, including land lines, microwaves, Internet, and combinations thereof

The following description of the methodology of the present invention is to be understood to implement in a software control program accessible from a central workstation or server by each individual terminal. Although not specifically described, suitable access verification, and a tiered hierarchy of authorized access levels, passwords, encryption, etc., may be employed to provide security for the entire process as well as to enable only authorized individuals to have access to certain functions, databases, etc.

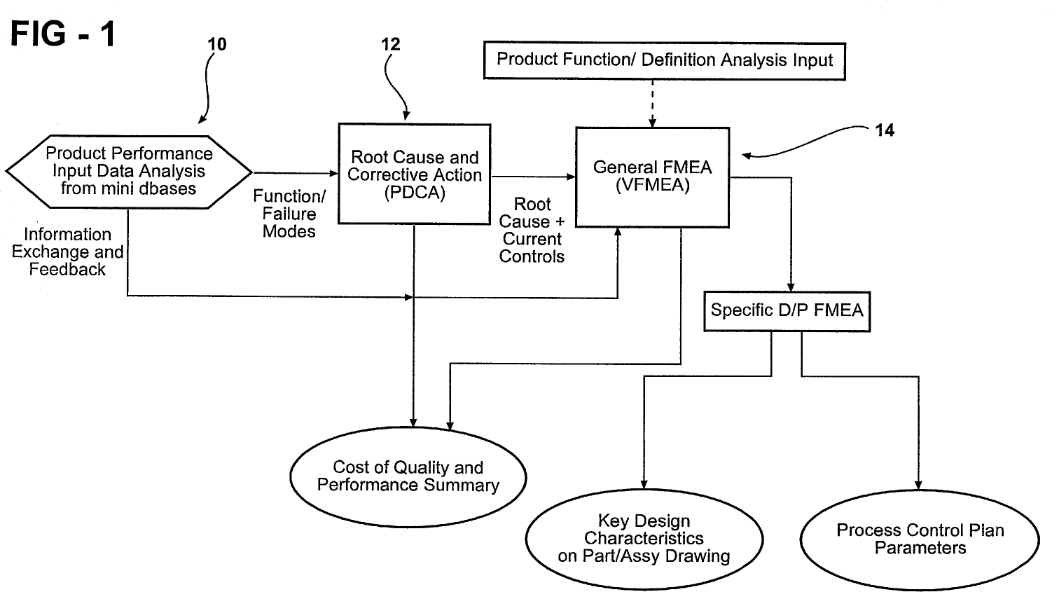

Referring now to FIG. 1, there is depicted a general flow diagram of the apparatus and method of the present product performance integrated database apparatus. The present apparatus includes three main sections: a product performance input database and analysis section 10, a root cause and corrective action (PDCA) section 12, and a general function mode and effect analysis section (VFMEA).

In the product performance input data analysis section 10, a plurality of databases shown in the following Table A are provided to receive various inputs on product performance and engineering/manufacturing changes. The failure recognition of a product or any component of a product are input into the various databases shown in Table A as a failure recognition.

TABLE A
Product Performance (PP) or
Eng./Manufacturing Change (PCR) Database List

| | |
|---|---|
| 1. | Field Performance-PP |
| | A-Launch (0 miles) |
| | B-Containment |
| | C-Warranty (> 0 miles) |
| | D-Extended Mileage (> warranty period) |
| 2. | Product Change Requests-PCR |
| | A-Engineering Change |
| | B-Manufacturing Change |
| 3. | Manufacturing Performance-PP |
| | A-EOLT (End of line test rejects) |
| | B-In-process |
| | C-Audit |
| 4. | Validation Performance |
| | A-DV (design verification) |
| | B-PV (process verification) |
| | C-CC (continuing conformance) |
| 5. | Proto/Pilot Bld. Inspection-PP |
| | A-Prototype component |
| | B-Pilot component |
| | C-Prototype asm. |
| | D-Pilot asm. |
| 6. | Measurement System Performance-PP |
| | A-Development Test Equipment |
| | B-Manufacturing Process Equipment |
| | C-Incoming insp. tool/gages |
| | D-Component supplier gage |
| 7. | Simulation-PCR |
| | A-Electrical E-Mold flow |
| | B-Mechanical F-EMI/EMC |
| | C-Thermal G-Geometric |
| | D-Fluid flow |
| 8. | Supplier Dev. Performance-PP |
| 9. | Process Control-PP |
| 10. | Production Process Capability Performance-PP |
| 11. | Manuf. Preventative Maintenance-PP |
| 12. | PPAD (Supplier & Company)-PCR |
| 13. | Engineering Dev. Test Performance-PP |
| 14. | Lessons Learned (General practices) |
| 15. | Engineering Calculation-PCR |
| 16. | Dimensional Tolerance Stack-up (Manual)-PCR |
| 17. | Internal/External part interface-PCR |
| 18. | New customer requirement-PCR |
| 19. | Supplier Requirement-PCR |
| 20. | Cost improvement-PCR |
| 21. | Drawing change-PCR |
| | A-Print to Part |
| | B-Part list |
| | C-Print dim. error |
| 22. | Tool Wear-PP |

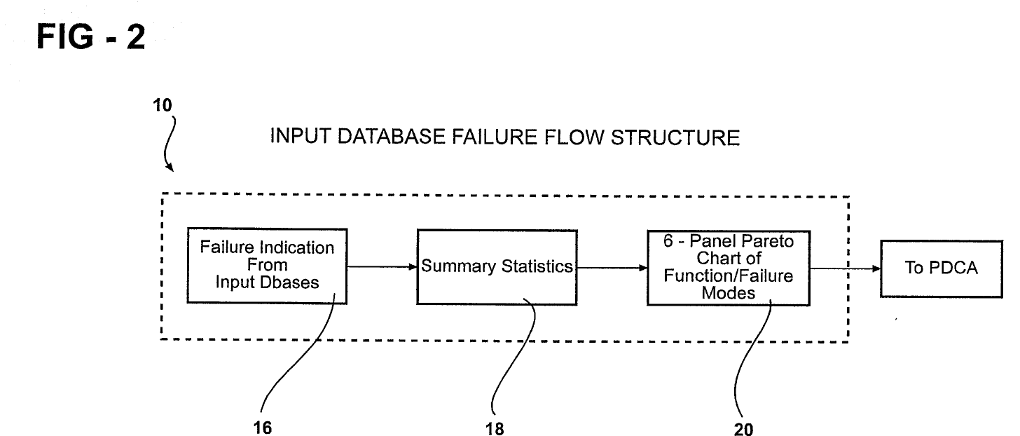

The present method takes the output of the failure indication from any of the input databases shown by reference number 16 in FIG. 2 and prepares summary statistics as shown by block 18. Table B shows the summary statistics which are calculated for the first seven failure recognition database features.

TABLE B
Summary Statistics

| Source (failure recognition) | Summary Statistics |
|---|---|
| 1. Field Performance | Fourteen product profiles that address: what, |
| | who, where, when, and quantity (see new field |
| | performance module) |
| 2. Product Change Requests | (within PDCA) |
| 3. Manufacturing Performance | Frequency of rejects per time (work, mos) and |
| | shift number. Function and/or failure mode |
| | reject types per above time interval |
| 4. Validation Test Performance | Life test reliability demo |
| | Total test success prob. |
| | Function and/or failure mode reject types/test |
| | and their frequency |
| 5. Prototype/Pilot Build Inspection Perf. | Component Cp and Cpk by parametric |
| | Asm bld yield |
| | Asm function/failure mode reject types |
| 6. Measurement Systems Performance | Calibration (% accuracy) |
| | Gage Total R + R % |
| 7. Simulation Performance | Frequency of failure mechanism per number of |
| | simulation sample runs |
| | Failure mechanism type recognized per |
| | simulation |
| | Failure mechanism/mode probability |

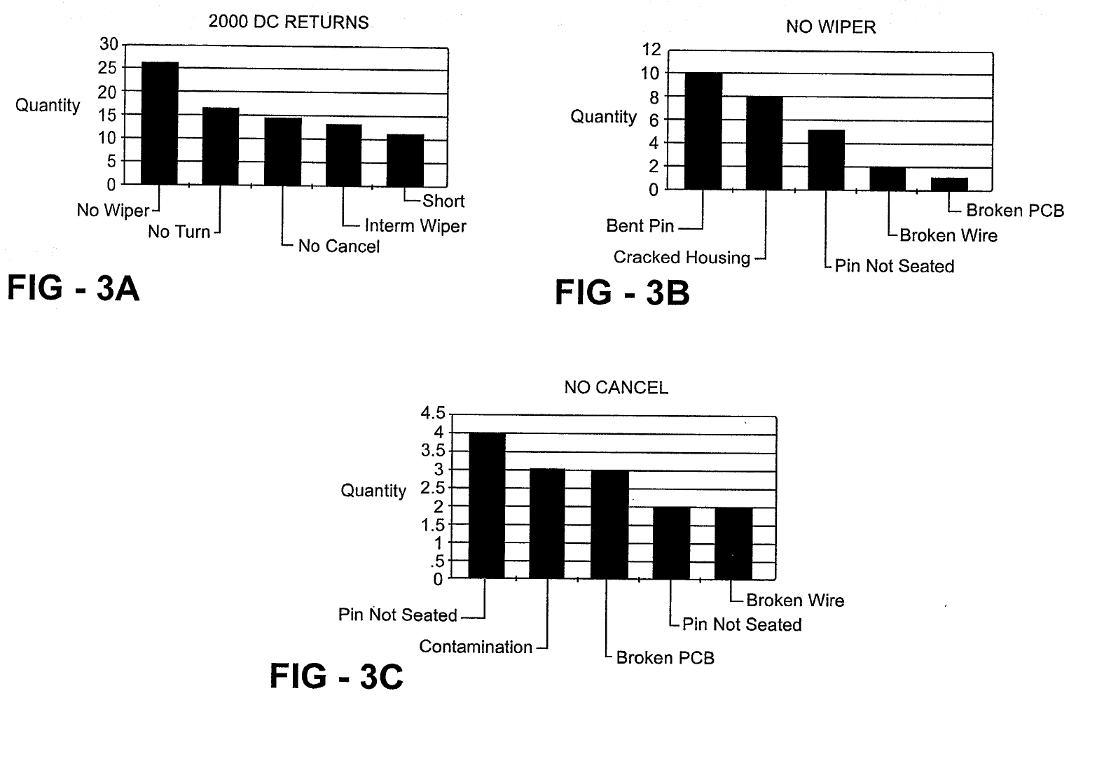

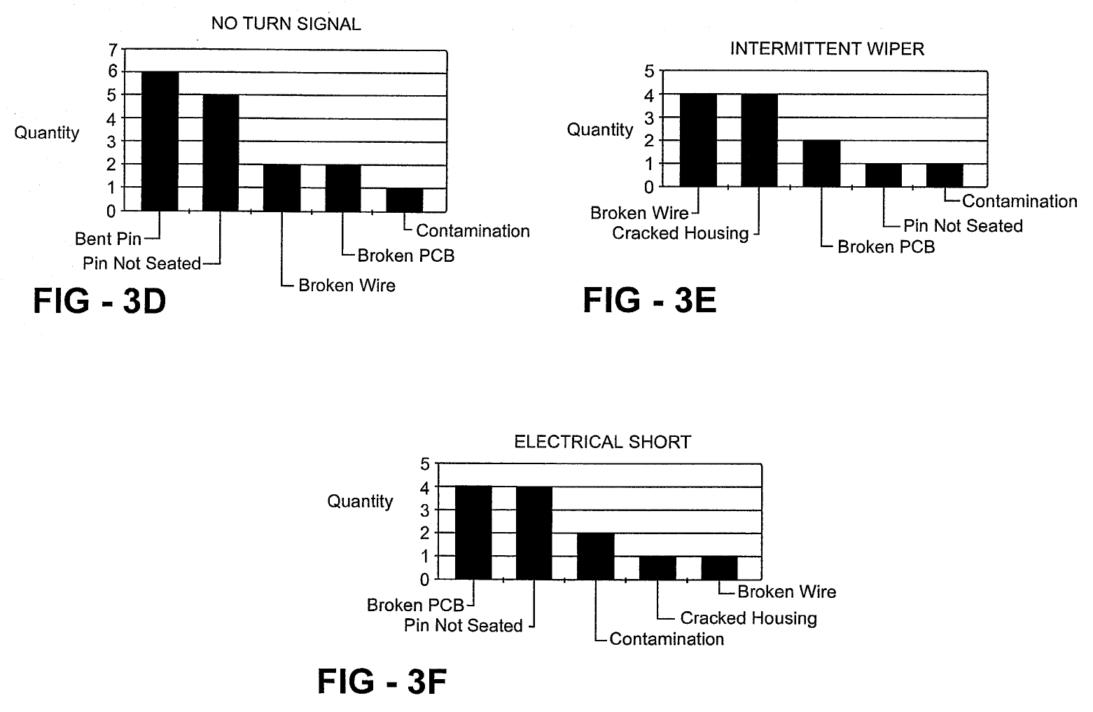

The output of the summary of statistics section 18 is used to create a Pareto chart of function/failure mode shown by reference number 20 in FIG. 2. A detailed example of a Pareto chart is shown in FIGS. 3A-3F for six different failures along with the number of occurrences of the failure modes of each reported failure. The number of failures in the chart can be varied as needed.

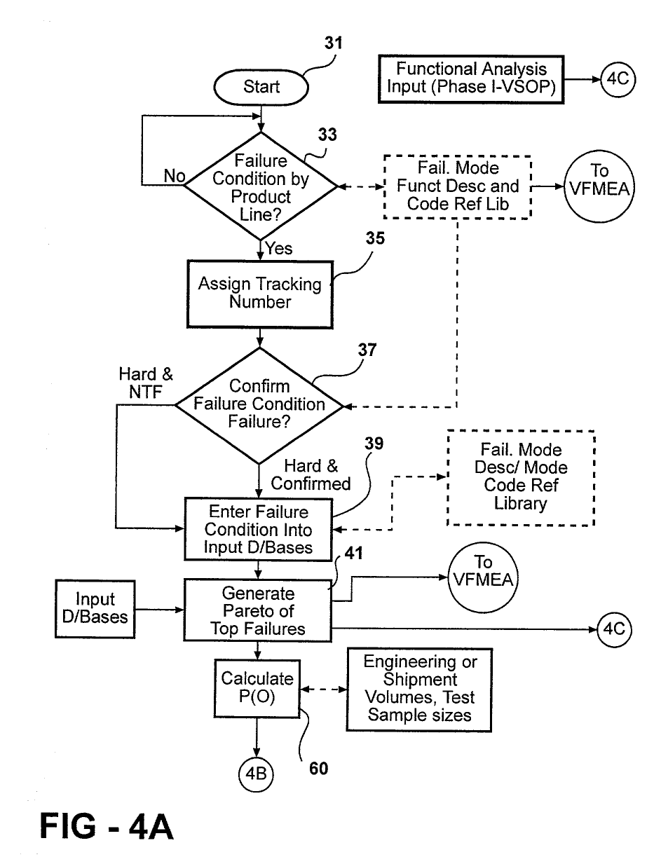

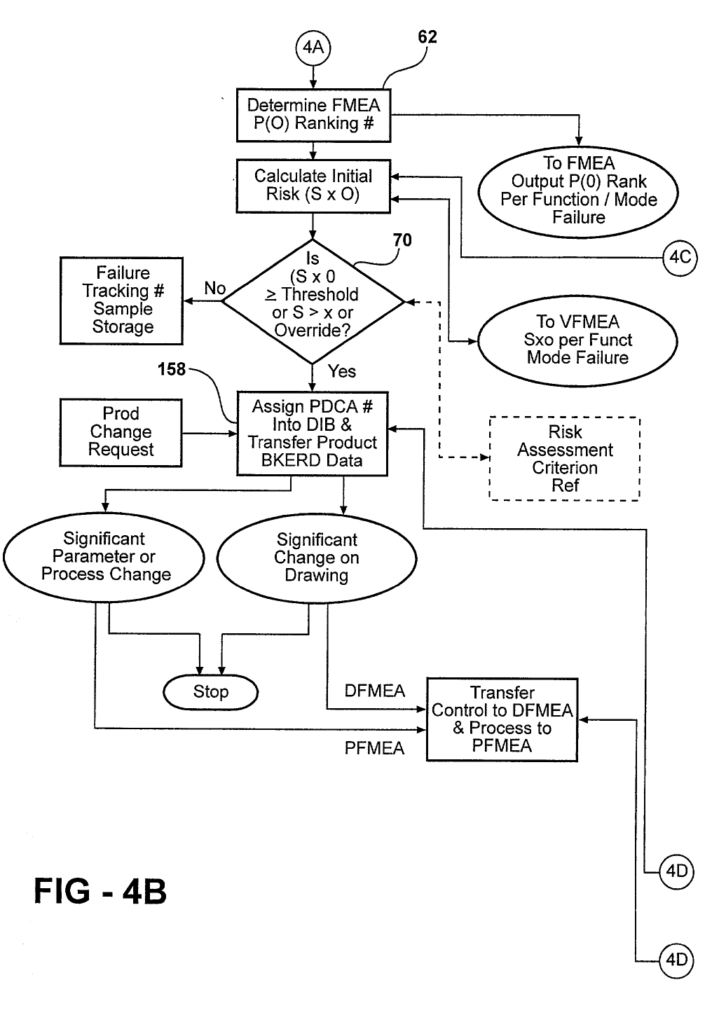

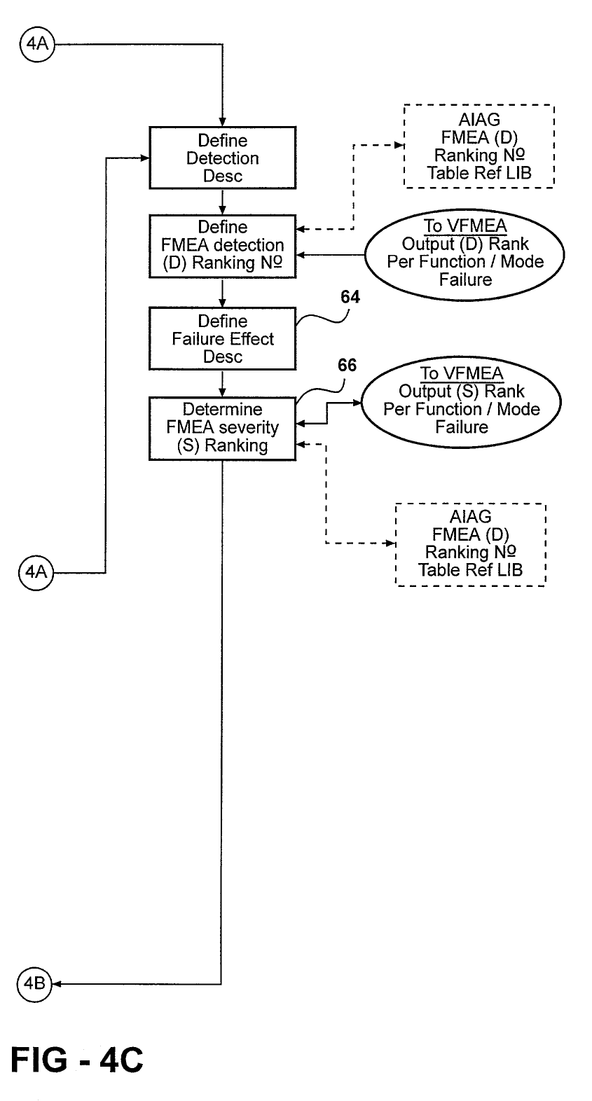

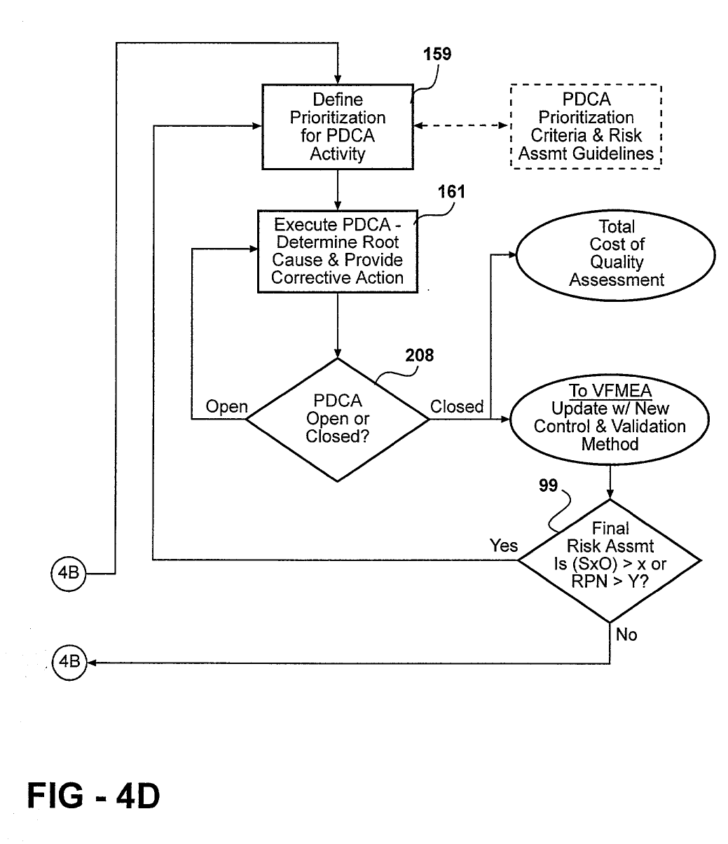

A procedure sequence is shown in FIGS. 4A-4D. Upon issuance of a start instruction 31, the sequence advances to a query in step 33 of whether an input is requested for a failure condition by a particular product line. A “yes” answer causes a tracking number to be assigned to the failure condition in step 35.

Next, the process confirms the failure condition in step 37. The output of this decision step 37 is either that an indication that a hard failure has occurred and has been confirmed or, alternately, that a hard failure has occurred, but is one which is not confirmed. Next, the reported failure condition is input in step 37 into the appropriate input database shown in Table A.

At periodic intervals, or at certain time tables during the product development process, the failures are analyzed and a Pareto chart of the top failures, based on number of failures, is prepared in step 41 as described above and shown in FIGS. 3A-3F. The Pareto chart of top failures is based on function and failure modes.

In the present method, control then switches to the FMEA section 14 shown in FIG. 1. The failure function and mode analysis, data and numbers from the Pareto chart are input to the FMEA section.

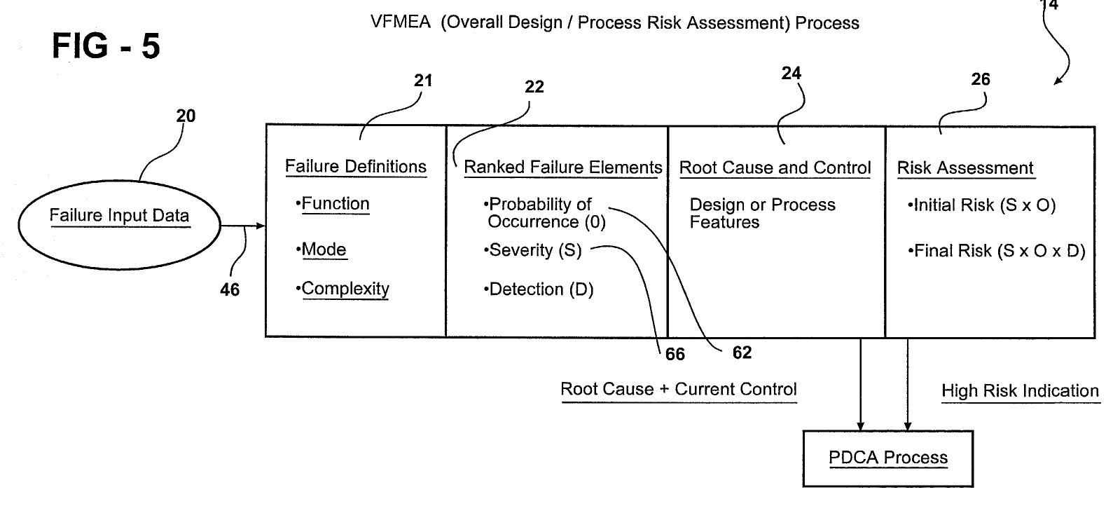

As shown in FIG. 5, the output 46 from the failure input data as contained in the Pareto function/failure chart is input to a failure definition section 21 in the FMEA section 14 for risk assessment.

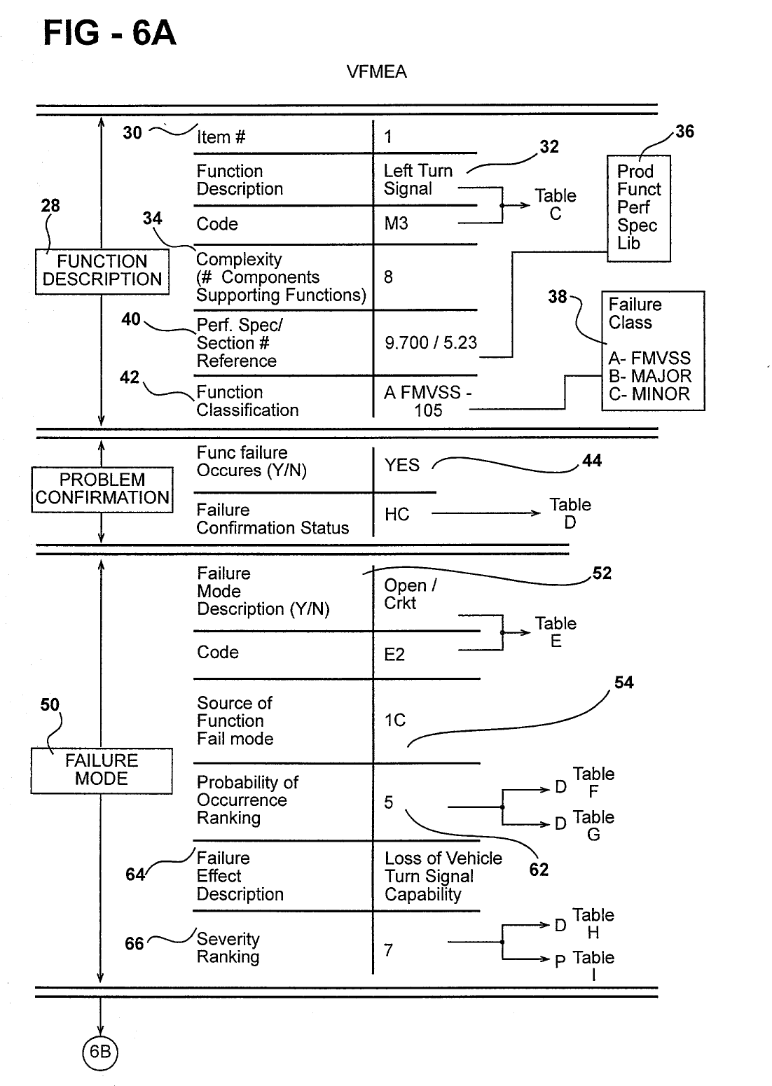

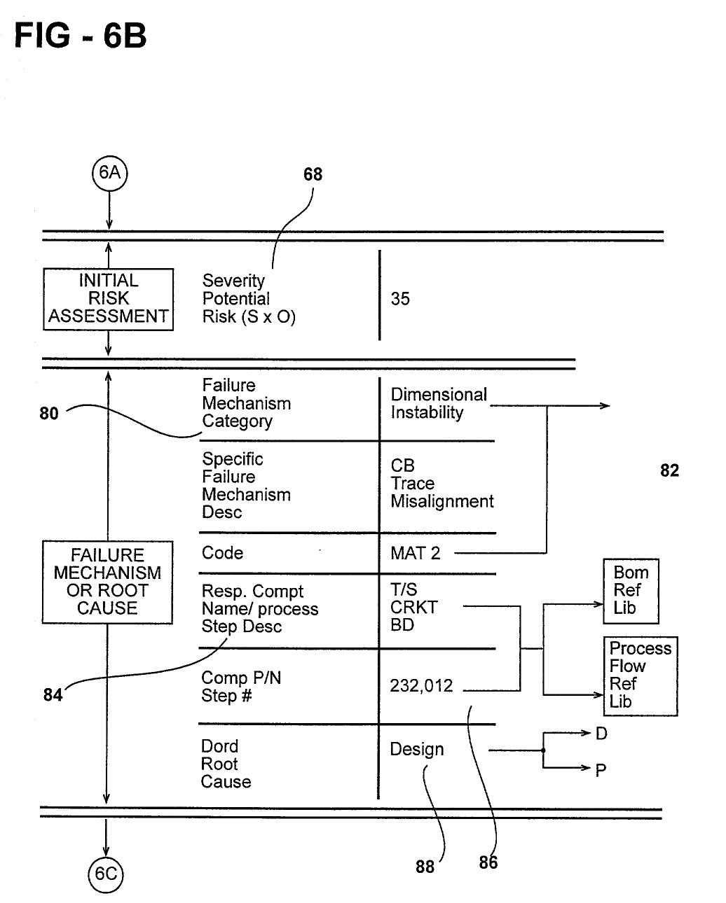

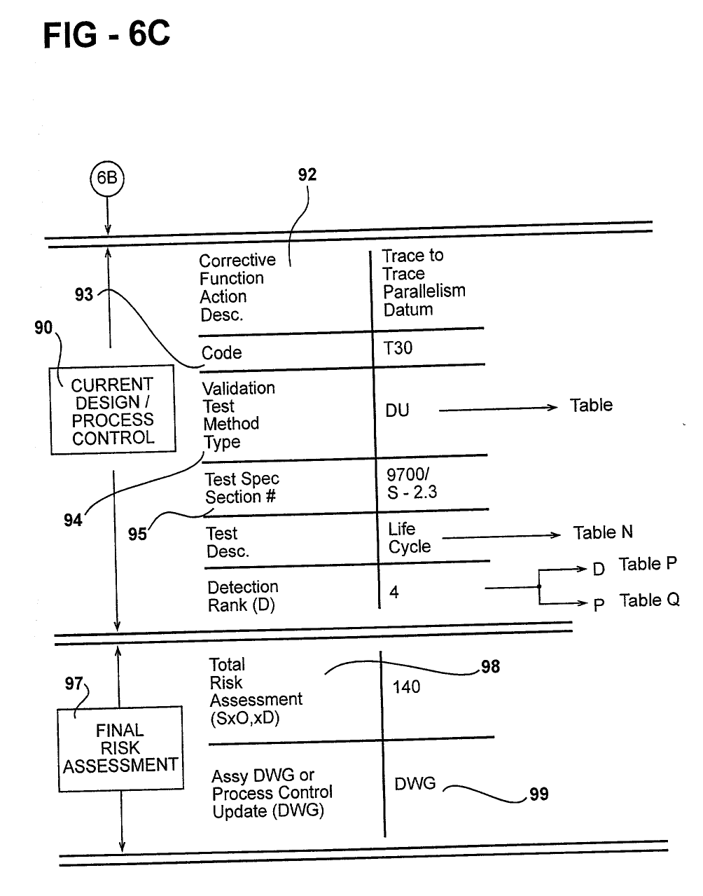

As shown in FIGS. 6A, 6B and 6C some of the initial information used in the (VFMBA) process is obtained from the input databases 10 as shown in FIG. 5. The (VFMEA) process 14 includes four main sections: failure definitions 21, ranked failure elements 22, root cause and control 24, and risk assessment 26.

In the failure definition section 21, a functional description 28 includes an input of an item number in step 30, a functional description 32 selected from the list shown in Table C and a function description code, also from the list shown in Table C, but not shown.

TABLE C
Multifunction Switch Function

| | |
|---|---|
| Left turn signal | Wash operation |
| Right turn signal | Low beam |
| Turn signal cancel | High beam |
| Headlamp switch | Cruise control on/off |
| Park lamp switch | Cruise control set/coast |
| Fog lamp switch | Cruise control resume/accel |
| Beam change (flash to pass) | Wiper delay - low speed mode |
| switch | |
| Hazard switch | Wiper delay - high speed mode |
| Dimmer switch | Wiper delay - intermittent speed modes |
| Mist operation | |

Next, in section 34, a degree of complexity number is input based on the number of components supporting the particular functional description. The performance specification and section number reference from the product function performance specification library 36 or the failure class 38, namely, (a) for (FMVSS), (b) for major and (c) for minor is input into sections 40, 42.

Next, the problem is confirmed by an indication of a function failure occurrence in section 44. This function failure confirmation status is selected from the list shown in Table D.

Within the present invention, the term “failure” means not only that a product or component has catastrophically failed, i.e, breaks, burns, cracks, etc., but also a product failure where the product does not meet some functional or dimensional design or process specification, or does not meet some visual inspection specification criteria, violates any industry or government standards, and, also a product design or process characteristic which meets specification criteria but exhibits significant variation within the criteria.

TABLE D
Failure Criterion
The following are definitions for the three different types of failure classifications which are
possible based on variable or attribute type date collected for either a product design or
manufacturing process.
1 - Hard and confirmed failure-HC

A hard and confirmed failure is defined as a product which exhibits at least one of the following
failure conditions and has been verified at least once after the initial complaint was registered:
A. Does not meet some functional or dimensional design/process specification criteria
B. Does not meet some visual inspection specification criteria
C. Violates any FMVSS or emission governmental standards.
D. Catastrophically fails (breaks, burns, cracks, etc.)

2 - Hard Failure and No Trouble Found (HNTF)

A hard and no trouble found failure is defined as a product which exhibits at least one of the
following failure conditions and has not successfully been verified at least once after the initial
complaint registered:
A. Does not initially meet some functional design/process specification criteria
B. Does not meet some visual inspection specification criteria
C. Violates any FMVSS or emission governmental standards

3 - NTF-NTF (NTF)
4 - Soft Failure

A soft failure is defined as a product design or process characteristic which meets specification
criteria but exhibits significant variation within these criteria. A violation of any of the following
statistical criteria constitutes a soft failure condition:
A. Pp (pre-production level) < 1.33
B. Ppk (pre-production level) < 1.33
C. Cp (production level) < 1.67
D. Cpk (production level) < 1.67

The failure mode is then defined in section 50. The description is entered in step 52 of the particular failure mode as selected from the list shown in Table E.

TABLE E
Switch Product Line Design and Process Failure Modes
This list applies to all electromechanical switch products
(multifunction, ignition, IP, door alarm, deck lid, hazard, etc.)

| | | |
|---|---|---|
| Electrical Function (E) | Noise (N) | Missing ID |
| Open circuit (high resistance) | BSR (buzz, squeak, or rattle) | Wrong ID |
| Short circuit (low resistance) | upon no function actuation | Wrong location |
| Intermittent circuit | BSR upon function actuation | No key way |
| High leakage current | Measurement (R) | Incorrect key way location |
| Mechanical Function (M) | Failed parts determined as | Wrong potting (adhesive) |
| No mechanical actuation | good | material |
| Erratic mechanical actuation | Good parts determined as | Misplaced component within |
| High mechanical force effort | failures | assembly |
| Low mechanical force effort | Visual - fit or form (V) | No wire crimp |
| Lack of mechanical force | Features warped | Inadequate wire crimp |
| effort | Misaligned components | Over-crimped (damage) |
| Binding/drag | Excessive gap | Inadequate wiring tinning |
| Unable to rotate/jams | Loose component | No wire tinning |
| Sticks upon rotation | Cracked | Excessive wire tinning |
| Excessive play | Broken | Burned appearance |
| Unable to latch/fasten | Wrong part/feature | Parts jams in fixture |
| Unable to unlatch | Wrong color | Part does not fit in fixture |
| Weak snap | Wrong texture | Lack of potting (adhesive) |
| Inadequate pre-load force | Missing component/feature | Excessive potting (adhesive) |
| No pre-load | Missing graphics | No illumination |
| Misindexing | Scratched | Intermittent illumination |
| Loss of function spring return | Chipped | Feel (F) |
| Early function actuation | Flash | High insertion force |
| Late function actuation | Cannot be connected/fastened | Low insertion force |
| Inadequate mechanical | Excessive grease | Variable insertion force |
| retention | Missing seal | High removal force |
| Overtravel | Exposed copper | Low removal force |
| Undertravel | Misplaced component/feature | Variable removal force |
| Will not change function states | Bent/deformed component | High temperature (overheat) |
| Loss of sealing capability | Sheared | Low temperature (too cold) |
| High mechanical torque | Wrong texture | Irregular surface smoothness |
| Low mechanical torque | Surface irregularities | Odor (O) |
| Inadequate fluid pressure | Mispositioned component | Burnt smell |
| Excessive fluid pressure | within system | |
| No fluid pressure | Foreign residue/particles | |

A code is assigned to the particular failure mode in step 54. Next, the source of the function or failure mode is entered in step 54 from Table A.

Referring back to FIG. 4B, in step 60, the function/failure mode probability of occurrence, defined as P(O)=the number of failures divided by the number of units shipped or tested, is calculated. The shipment volumes or test sample size are obtained from manufacturing shipment and test specification sample reference library databases. The value of P(O) is applied to a probability of occurrence/ranking look-up table, with separate tables being provided for design and process failure modes, as shown in Tables F and G. The ranking value associated with the particular possible failure rate is entered in column 62 in FIG. 6A.

TABLE F
Frequency or Probability of Occurrence

| O | DSDSA Criteria |
|---|---|
| 1 | Defect not present on existing or similar products used in similar functions and conditions. |
| | No incident known among customers. x ≦ 1/1,500,000 [x ≦ .67 ppm] and for measured |
| | parametric Cp ≧ 1.67 and Cpk ≧ 1.67 |
| 2 | 1/1,500,000 < x ≦ 1/150,000 [0.67 ppm < x ≦ 6.67 ppm] and for measured parametric 1.5 < |
| | Cp ≦ 1.67 and 1.45 < Cpk ≦ 1.67 |
| 3 | Few defects on existing or similar products used in similar functions and conditions. Very |
| | few incidents known among customers. 1/150,000 < x ≦ 1/15,000 [6.67 ppm < x ≦ 66.67 ppm] |
| | and for measured parametric 1.33 < Cp ≦ 1.5 and 1.27 < Cpk ≦ 1.45 |
| 4 | 1/15,000 < x ≦ 1/2,000 [66.67 ppm < x ≦ 500 ppm] and for measured parametric 1.16 < Cp |
| | ≦ 1.33 and 1.10 < Cpk ≦ 1.27 |
| 5 | Defect that appeared occasionally on existing or similar products used in similar functions |
| | and conditions. A few incidents known among customers. 1/2,000 < x ≦ 1/500 [500 ppm < |
| | x ≦ 2,000 ppm] and for measured parametric 1.03 < Cp ≦ 1.16 and 0.96 < Cpk ≦ 1.10 |
| 6 | 1/500 < x ≦ 1/200 [2,000 ppm < x ≦ 5,000 ppm] and for measured parametric 0.94 < Cp ≦ 1.03 |
| | and 0.86 < Cpk ≦ 0.96 |
| 7 | Defect that appeared frequently on existing or similar products used in similar functions and |
| | conditions. Numerous incidents known among customers. 1/200 < x ≦ 1/100 [5,000 ppm < |
| | x < 10,000 ppm] and for measured parametric 0.86 < Cp ≦ 0.94 and 0.78 < Cpk ≦ 0.86 |
| 8 | 1/100 < x ≦ 1/50 [10,000 ppm < x ≦ 20,000 ppm] and for measured parametric 0.78 < Cp ≦ 0.86 |
| | and 0.69 < Cpk ≦ 0.78 |
| 9 | Defect appeared more often. Risk that vehicles have to be recalled 1/50 < x ≦ 1/20 [20,000 ppm |
| | < x ≦ 50,000 ppm] and for measured parametric 0.64 < Cp ≦ 0.78 and 0.55 < Cpk ≦ 0.69 |

TABLE G
Suggested Evaluation Criteria: (Process)

| | Possible Failure | | |
|---|---|---|---|
| Probability of Failure | Rates | Cpk | Ranking |
| Very High: Failure is almost | ≧1 in 2 | <0.33 | 10 |
| inevitable | 1 in 3 | ≧0.33 | 9 |
| High: Generally associated with | 1 in 8 | ≧0.51 | 8 |
| processes similar to previous | 1 in 20 | ≧0.67 | 7 |
| processes that have often failed | | | |
| Moderate: Generally associated | 1 in 80 | ≧0.83 | 6 |
| with processes similar to previous | 1 in 400 | ≧1.00 | 5 |
| processes which have experienced | 1 in 2,000 | ≧1.17 | 4 |
| occasional failures, but not | | | |
| in major proportions. | | | |
| Low: Isolated failures associated | 1 in 15,000 | ≧1.33 | 3 |
| with similar processes. | | | |
| Very Low: Only isolated failures | 1 in 150,000 | ≧1.50 | 2 |
| associated with almost identical | | | |
| processes. | | | |
| Remote: Failure is unlikely. No | ≦1 in 1,500,000 | ≧1.67 | 1 |
| failures ever associated with almost | | | |
| identical processes. | | | |

Concurrent with, or subsequent to, the calculation of the probability of occurrence of value P(O), the particular severity ranking is determined by describing in step 64 in the failure mode section, the particular effect of the specific failure. Example of severity effect is shown in FIG. 6B.

Next, step 66 generates a severity ranking for either a design or process failure selected from Tables H and I, respectively. A particular severity ranking is the input in step 66.

TABLE H
Severity of Effect (Design)

| S | Criteria |
|---|---|
| 1 | No discernible effect |
| 2 | Failure effect noticed by discriminating users. No loss of function |
| 3 | Intermittent out-of-range function, fit or audible performance |
| 4 | Continuous out-of-range function, fit or audible performance |
| 5 | Loss of single convenience/comfort function (single UPA sensor not working single tell-tale |
| | signal not working, etc.) |
| 6 | Loss of multiple convenience/comfort functions (all channels down, all tell-tales not working |
| | etc.) |
| 7 | Intermittent loss of critical function, e.g. power-supply |
| 8 | Loss of critical function, e.g. power-supply |
| 9 | Intermittent loss of function related to safety or regulatory items, e.g. headlamps, lock- |
| | unlock, wiper control, etc. |
| 10 | Sudden loss of function related to safety or regulatory items: headlamps, lock-unlock, wiper |
| | control, etc. |

TABLE I
Suggested Evaluation Criteria: (Process)

| Effect | Criteria | Ranking |
|---|---|---|
| Hazardous - without | May endanger machine or assembly operator. Very high | 10 |
| warning | severity ranking when a potential failure mode affects safe | |
| | vehicle operation and/or involves noncompliance with | |
| | government regulation. Failure will occur without warning. | |
| Hazardous - with | May endanger machine or assembly operator. Very high | 9 |
| warning | severity ranking when a potential failure mode affects safe | |
| | vehicle operation and/or involves noncompliance with | |
| | government regulation. Failure will occur with warning. | |
| Very High | Major disruption to production line. 100% of product may | 8 |
| | have to be scrapped. Vehicle/item is inoperable, with loss of | |
| | primary function. Customer very dissatisfied. | |
| High | Minor disruption to production line. Product may have to be | 7 |
| | sorted and a portion (<100%) scrapped. Vehicle/item is | |
| | operable, but at reduced level of performance. Customer | |
| | dissatisfied. | |
| Moderate | Minor disruption to production line. A portion (<100%) of the | 6 |
| | product may have to be scrapped (no sorting). Vehicle/item is | |
| | operable, but Comfort/Convenience item(s) inoperable. | |
| | Customer experiences discomfort. | |
| Low | Minor disruption to production line. 100% of product may | 5 |
| | have to be reworked. Vehicle/item is operable, but | |
| | Comfort/Convenience item(s) inoperable at reduced level of | |
| | performance. Customer experiences some dissatisfaction. | |
| Very Low | Minor disruption to production line. The product may have to | 4 |
| | be sorted and a portion (<100%) reworked. Fit | |
| | &Finish/Squeak & Rattle item does not conform. Defect | |
| | noticed by most customers. | |
| Minor | Minor disruption to production line. Fit &Finish/Squeak & | 3 |
| | Rattle item does not conform. Defect noticed by average | |
| | customers. | |
| Very Minor | Minor disruption to production line. A portion (<100%) of | 2 |
| | the product may have to be reworked on-line but in-station. | |
| | Fit &Finish/Squeak & Rattle item does not conform. Defect | |
| | noticed by discriminating customers. | |
| None | No effect. | 1 |

Next, in step 68, an initial risk calculation is made (S×O) for each function/failure mode from the Pareto chart 20. The product of (S×O) is input into the database. Next, as shown in FIG. 4B, the initial risk of assessment value is compared with an initial risk assessment threshold in step 70. Several criteria are involved in this determination. First, the initial risk assessment value is compared with the threshold, for example, at the threshold of 20. Risk assessments greater than or equal to 20 are considered a high risk assessment and are flagged for immediate action. Risk assessments less than 20 are of lesser priority and can be considered after failures having higher risk assessment values are addressed. Alternately, a high priority risk assessment can be assigned to any severity ranking greater than a different threshold, such as a threshold of 7, by example only.

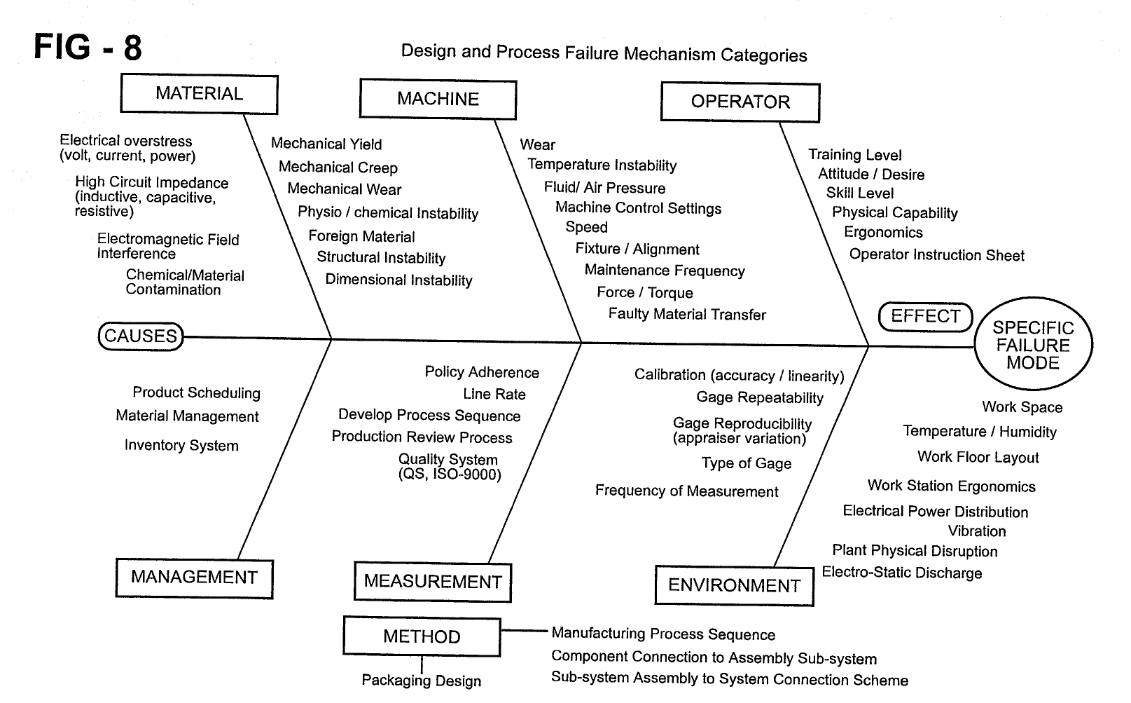

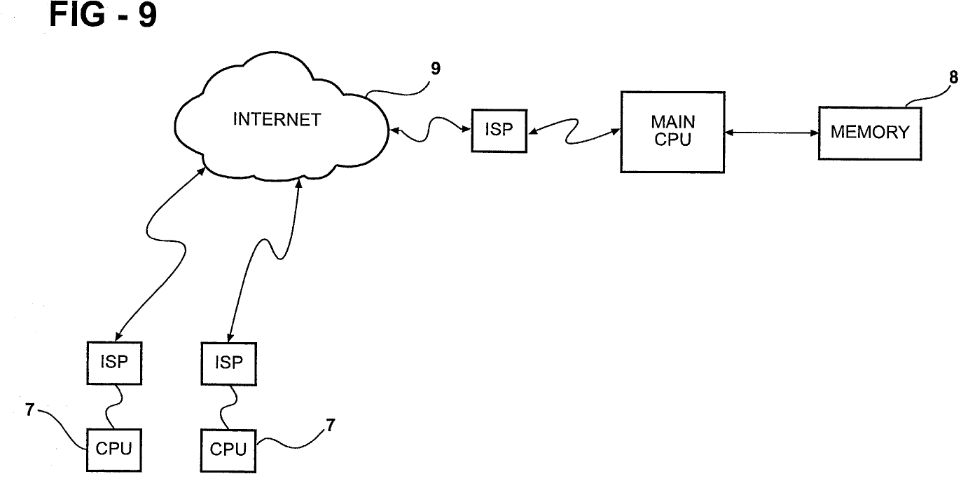

A failure mechanism or root cause analysis (PDCA) is then started for high priority risk assessments. Some of the information from this section can be obtained from (PDCA) data defined separately in the above-described steps. For example, a particular failure mechanism category input is provided in step 80 in FIG. 6B. The particular specific failure mechanism is then described in step 82. A code is assigned to the failure mechanism described in step 82. The fishbone diagram shown in FIG. 8 is then employed to help brainstorm and identify the root cause category for the particular failure mode in question. Other inputs include the responsible component name or process step description in step 84, the component part number or process step number in step 86 and whether the root cause is a design or process failure in step 88.

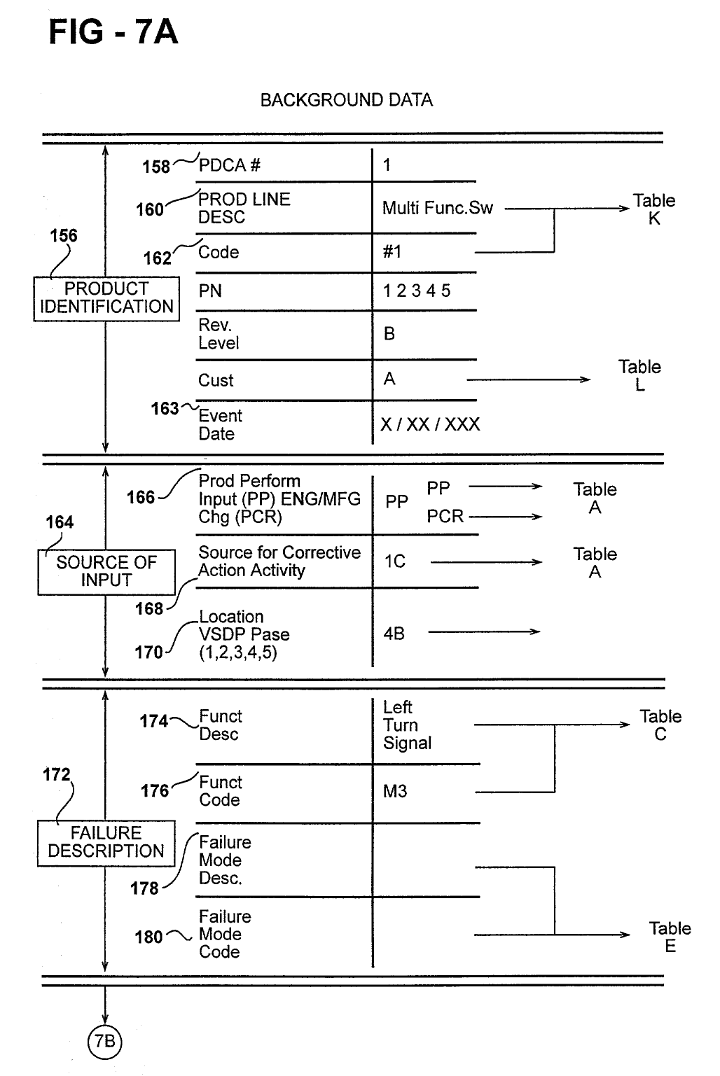

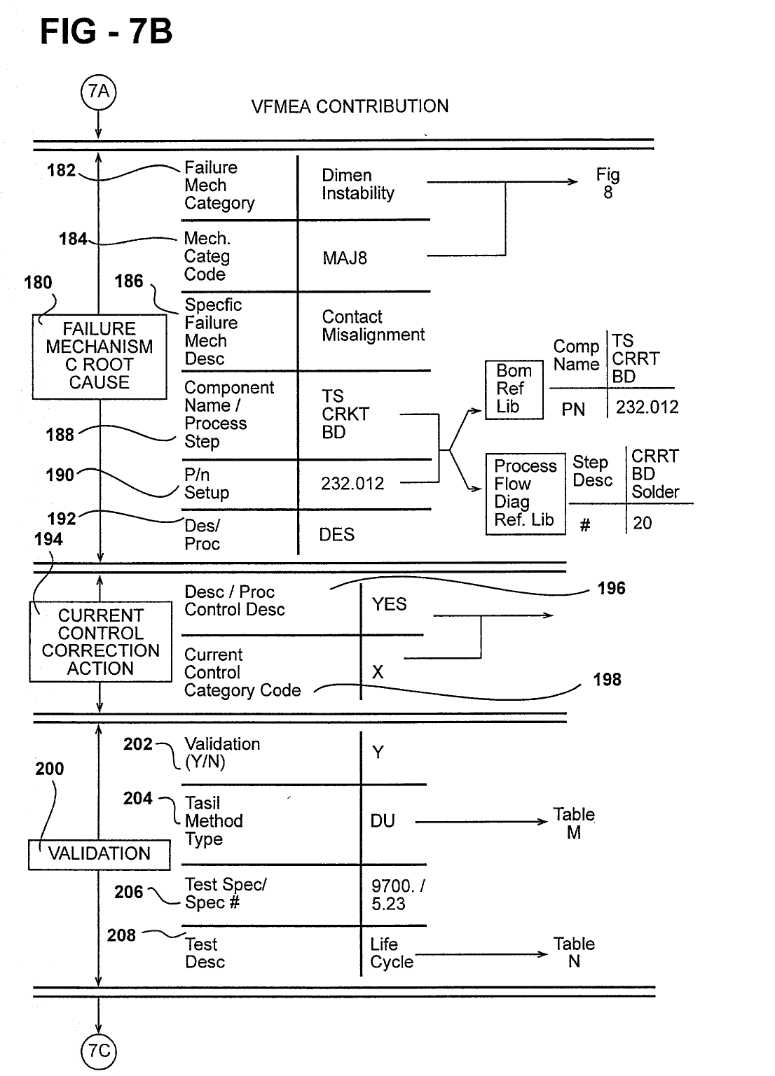

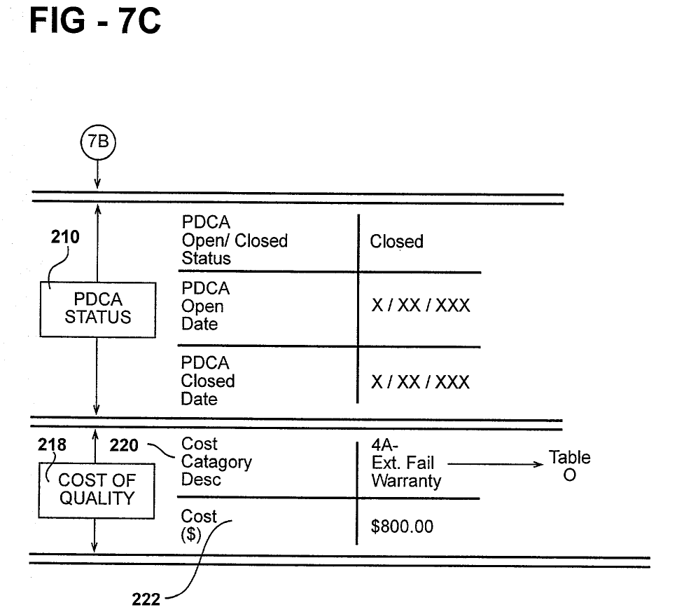

A more complete PDCA process can be implemented as shown in FIGS. 7A and 7B. The formal PDCA procedure involves the following steps:

1. Prioritize;

2. Brainstorm root causes(s) (Fishbone Diagram);

3. Justify causes with available supporting data;

4. Isolate most significant cause(s);

5. Institute design or process corrective action;

6. Validate;

7. Open/close status; and

8. Assess cost of quality.

The following Table J is a list which helps to establish a prioritization scheme for directing failure root cause and corrective action activity as defined in the PDCA database. This priority scheme is followed once significant risk is established (see procedure flow chart and Risk Assessment Guide Sheet). A lower number/letter combination for a specific product failure condition represents higher priority given to initiating the PDCA process. These failure conditions would originate from one of the specific input databases:

TABLE J
PDCA Prioritization Criterion
1 - Hard and confirmed failure-HC

A. Engineering/Manufacturing Changes (internal to PDCA)
B. Product Launch Failures
C. Field (at the customer assembly plant) Failures
D. Field (through the dealership and in the field) Failures
E. Manufacturing Yield and Rework Failures (EOLT and in-process defects)
F. Continuing Conformance Failures - Validation database
G. DV or PV Test Failures - Validation database
H. Measurements Systems Capability (total gage R&R < 30%)
I. Simulation Failures

2 - Hard and No Trouble Found (NTF) Failures

A. Product Launch Failures
B. Field (at the customer assembly plant) Failures
C. Field (through the dealership and in the field) Failures
D. Manufacturing Yield and Rework Failures (EOLT and in-process defects)
E. Continuing Conformance Failures - Validation database
F. DV or PV Test Failures - Validation database

4 - Soft Failure

A. Process Control (process characteristics exceed process control limits)
B. Process Capability (incapable process characteristics)
C. Supplier Performance (incoming inspection or Supplier outgoing inspection incapability)
D. Prototype inspection (incapable key component/assembly characteristics)

Before the various formal procedural steps shown in FIG. 4C can take place, certain background data must be assembled. As shown in FIG. 7A, the background data consists of three main sections, namely, product identification 156, source of input 164 and failure description 172.

The product identification section 156 includes a number of categories, including the (PDCA) tracking number 158 and a product line description 160. The following Table K shows an example of a product line description for section 160.

TABLE K
Product Line Descriptions

Sensors
Ultrasonic Park Assist (UPA)
Crankshaft
Camshaft
Rain
Steering Angle
Electromechanical Switches
Multifunction
Door Alarm
Door Ajar
Ignition
Hazard
Instrument Panel Switch
Clockspring
Key Alarm
Decklid
Passenger Switch Inflatable Restraint (PSIR)
Electric Control Modules
Body
Wiper
UPA
Rain
Climate
Rear Integrated Module (RIM) - body control
Others
UPA Speaker
Wiper Motor
Wiper Actuator

A code in section 162 is assigned to each of the product line descriptions. A part number and a revision level are also assigned. Next, the customer is identified by code which can be provided in Table K. The event date of the failure or failure input is then recorded in section 163.

TABLE L
Customer List

| OEM | 1st Tier |
|---|---|
| Company A | Company F |
| Company B | Company G |
| Company C | Company H |
| Company D | Company I |
| Company E | |

The next section 164 determines the source of the failure recognition input. In section 166, a determination is made whether the failure mode is a product performance input (PP) or an engineering/manufacturing change (PCR) these inputs are received from the input databases shown in Table A.

Next, in section 168, the source for corrective action activity is defined from Table A. Finally, the location in the (VSDP) phase is defined in section 170.

Next, in the failure description section 172, the function description of the failure is defined in step 174 from Table C and assigned a function code in section 176. An example of typical function descriptions for a multi-function switch, described by way of example only, is provided in Table C. Next, in section 178, a failure mode description and a failure mode code in step 180 is assigned to each failure description. Table E gives an example of failure modes for a switch product line design and process failure. It will be understood that this is only an example of failure modes for switches. Other failure modes will be defined for other components.

Next, section 180 is used to define the root cause of the failure mechanism. First, a failure mechanism category is selected in step 182 and assigned a code in step 184. FIG. 8 depicts a fishbone diagram of design and process failure mechanism categories for input into section 182. One example of a failure mechanism category is shown by “dimensional instability” in FIG. 7B. The fishbone diagram brings together individuals in different disciplines to brainstorm as to the particular failure mechanism which is the root cause of the reported failure.

The output of the brainstorming session, either at one meeting or after further review and investigation, should result in the definition of a specific failure mechanism in section 186. One example of such a description is shown in FIG. 7B. Next, the reporting process includes an identification of the particular component name or process step in section 188 followed by a part number in step 190 and an indication of whether the specific failure mechanism is a design or process in step 192.

Sections 188 and 190 make reference to databases which store bill of material reference library and a process flow diagram library to determine component names and part numbers or process step descriptions and step numbers.

These (PDCA) contribution steps are summarized in FIG. 4C in which the assignment of the (PDCA) number in step 158 is the initial step in the (PDCA) procedure which then continues to define prioritization for (PDCA) activity in step 159. Next, in step 161, the (PDCA) is executed to determine the root cause and provide design/process control methods or corrective action.

Referring back to FIG. 7B, in a specific section labeled current control for corrective action shown by reference number 194, a description is entered as to the current design or process control description in step 196 along with a particular current control category code in step 198. One example of a control description is shown in FIG. 7B.

The next section 200 is validation. Whether or not validation has been made is input in step 202. The test method type is then input in step 204 from the following Table M:

TABLE M
Test Method Type

1. DV
2. PV
3. CC
4. Dimensional stack
5. Engineering calculation
6. FEA simulation
7. Prototype inspection
8. Pilot build inspector

The particular test specification and section number from the reference library is supplied in step 204. Next, the particular validation test to be employed to validate the corrective action is input in step 206 from a list shown in the following Table N.

TABLE N

```
  1. Thermal soak
  2. Thermal cycling
  3. Random mechanical vibration
  4. Mechanical shock
  5. Thermal shock
  6. Sinusoidal Mechanical vibration
  7. Humidity soak
  8. Humidity cycling
  9. Fluids compatibility
10. EMI
11. EMC (electromagnetic compatibility)
12. ESD (electro-static discharge)
13. Voltage transients
14. Mechanical pull test
15. Life cycle (combined environments)
16. Electrical functionals
A-voltage
B-current
C-resistance
D-electric field strength
E-power
F-capacitance
G-inductance
H-frequency
I-impedance
17. Mechanical functionals
A-force
B-displacement
C-torque
D-mass
E-work
F-energy
G-horsepower
18. Illuminance functionals
A-Light intensity (CP)
B-Wavelength
19. Audible functionals
A-gain
B-frequency response
```

As shown by step 208 in FIGS. 4C and 7B, the next input is the current (PDCA) status in section 210. An input is entered as to the open or closed status of the (PDCA) along with the (PDCA) open date and the (PDCA) close date.

Finally, an initial cost of quality assessment is made in section 218. A cost category description is entered in step 220 from the following Table O along with an estimate in step 222 of the quality costs.

TABLE O

| Prevention Costs | Appraisal Costs | Failure Costs |
|---|---|---|
| Design Reviews | Prototype Inspection-PP | Engineering Change Order- |
| Risk Assessment | Pilot Build Inspection-PP | PCR |
| Simulation-PCR | Product/process Verification | Redesign |
| Specification Review | Test-PP | Purchasing Change Order-PCR |
| Product Qualification | Incoming and Outgoing | Scrap (in process or EOLT)- |
| Drawing Checkout | Inspection | PCR |
| Process Control Plan | Measurement Evaluation and | Rework (in process or EOLT)- |
| Process Performance and | Test-PP | PCR |
| Capability Studies-PP | Process Control Acceptance | Warranty-PP |
| Tool and Equipment Studies- | Packaging Inspection | Extended Mileage-PP |
| PP | Supplier Audit-PP | Product Liability |
| Product Acceptance Planning | Company Manufacturing | Service |
| Product Assurance Planning | Audit-PP | Containment (Sort)-PP |
| Operator Training | | |
| Quality and Reliability | | |
| Training | | |

TC = Prevention Costs + Appraisal Costs + Failure Costs

Next, as shown in FIG. 6C for the FMEA module, the current design/process control sequence 90 is implemented. This sequence involves an input of the corrective function action description action in step 92 along with a code assigned to the particular action in step 93. Next, the validation test method selected by product development group is selected from the test method list described above. The particular test specification and section number from the reference library is then input in step 95. The test description, such as life cycle, for example only, is selected from the list shown in Table N. Next, a detection ranking is determined by the development group from the detection ranking criteria for designs in Table P or for processes in Table Q.

TABLE P
New DFMEA Detection Ranking Methodology (Design)
Location of Verification Method Activity per Valeo Structured Development Process

| | | Engineering | Development | Prototype | DV | Pilot Build | PV | |
|---|---|---|---|---|---|---|---|---|
| Test Method | Simulation | Calculation | Testing | Inspection | Testing | Inspection | Testing | |
| Characteristics | (Phase 2) | (Phase 2) | (Phase 2) | (Phase 2) | (Phase 2) | (Phase 3) | (Phase 3) | None |
| Validates* (with GRR)**, | 1 | 2 | 3 | 4 | 4 | 5 | 6 | 10 |
| high sample size, and | | | | | | | | |
| time non-terminated*** | | | | | | | | |
| Validates (with GRR), | 1 | 2 | 4 | 4 | 5 | 5 | 7 | 10 |
| high sample size, and | | | | | | | | |
| time-terminated | | | | | | | | |
| Validates (with GRR), | 1 | 2 | 4 | 5 | 5 | 6 | 7 | 10 |
| low sample size, and | | | | | | | | |
| time non-terminated | | | | | | | | |
| Validates (with GRR), | 1 | 2 | 5 | 5 | 6 | 6 | 8 | 10 |
| low sample size, and | | | | | | | | |
| time-terminated | | | | | | | | |
| Validates w/o GRR, | N/A | N/A | 6 | 6 | 7 | 7 | 9 | 10 |
| high sample size, and | | | | | | | | |
| time non-terminated | | | | | | | | |
| Validate w/o GRR, | N/A | N/A | 7 | 6 | 8 | 7 | 9 | 10 |
| high sample size, and | | | | | | | | |
| time terminated | | | | | | | | |
| Validates w/o GRR, | N/A | N/A | 7 | 7 | 8 | 8 | 10 | 10 |
| low sample size, and | | | | | | | | |
| time non-terminated | | | | | | | | |
| Validates w/o GRR, | N/A | N/A | 8 | 7 | 9 | 8 | 10 | 10 |
| low sample size, and | | | | | | | | |
| time terminated | | | | | | | | |

Notes:
*“validates” refers to the ability to provide the stress conditions for the specific failure mode.
**“(with GRR)” refers to measurement system repeatability and reproducibility < 10% of parameter tolerance.
***“time non-terminated” refers to extended testing beyond test time (or cycle) requirement.

TABLE Q
Process Determination
Location of Verification Method Activity per Valeo Structured Development Process

| | | | Statistical | | | | | |
|---|---|---|---|---|---|---|---|---|
| | | | Process | Incoming | | | | |
| | | Pre-Production | Control | Inspection | In-Process | In-Process | | |
| | | Demonstration | (Variable/ | (Measured | Inspection | Inspection | EOL | |
| Test Method | Simulation | Evaluation | Attribute) | & Visual) | (Measured) | (Visual) | Testing | |
| Characteristics | (Phase 3) | (Phase 2) | (Phase 4A) | (Phase 4B) | (Phase 4B) | (Phase 4B) | (Phase 4B) | None |
| Validates* (with GRR)**, | 1 | 2 | 3 | 4 | 4 | 5 | 6 | 10 |
| high sample size, and | | | | | | | | |
| time-terminated | | | | | | | | |
| Validates (with GRR), | 1 | 2 | 4 | 4 | 5 | 5 | 7 | 10 |
| high sample size, and | | | | | | | | |
| time-terminated | | | | | | | | |
| Validates (with GRR), | 1 | 3 | 4 | 5 | 5 | 6 | 7 | 10 |
| low sample size, and | | | | | | | | |
| time non-terminated | | | | | | | | |
| Validates (with GRR), | 1 | 3 | 5 | 5 | 6 | 6 | 8 | 10 |
| low sample size, and | | | | | | | | |
| time-terminated | | | | | | | | |
| Validates w/o GRR, | N/A | 4 | 6 | 6 | 7 | 7 | 9 | 10 |
| high sample size, and | | | | | | | | |
| time non-terminated | | | | | | | | |
| Validates w/o GRR, | N/A | 4 | 7 | 6 | 8 | 7 | 9 | 10 |
| high sample size, and | | | | | | | | |
| time terminated | | | | | | | | |
| Validates w/o GRR, | N/A | 5 | 7 | 7 | 8 | 8 | 10 | 10 |
| low sample size, and | | | | | | | | |
| time non-terminated | | | | | | | | |
| Validates w/o GRR, | N/A | 5 | 8 | 7 | 9 | 8 | 10 | 10 |
| low sample size, and | | | | | | | | |
| time terminated | | | | | | | | |

Notes:
*“validates” refers to the ability to provide the stress conditions for the specific failure mode.
**“(with GRE)” refers to measurement system repeatability and reproducibility < 10% of parameter tolerance.
***“time non terminated” refers to extended testing beyond test time (or cycle) requirement

With the detection ranking value, the final risk assessment can be made in section 97. The total risk assessment number (RPN) is calculated by the equation (RPN=S×O×D) is then calculated in step 98. The total risk assessment (RPN) can be compared with a threshold as shown in step 99 in FIG. 4D, such as 125 for example. Any values of (RPN) for a particular failure greater than this threshold can be used as an indication that the particular root cause does not reduce substantially the failure risk for the product. Control can be routed back to the (PDCA) section 18 for a determination of a new failure effect root cause.

Finally, design control is transferred to (DFMEA) and process control to (PFMEA) for updating of part drawings or process control plans.

What is claimed is:

1. A method of determining product performance comprising the steps of:
collecting product performance data;
determining the failure mode of detected product failures;
conducting a failure mode effect and analysis procedure to determine a degree of risk of a detected failure; and
developing corrective action to correct the detected failures.

2. The method of claim 1 wherein determining the degree of risk comprises the steps of:
determining the severity of the effect of each failure; and
determining the frequency of occurrence of the effect of each failure.

3. The method of claim 2 further comprising the step of:
ranking the determined severity of effects of a plurality of different detected failures to generate a plurality of different severity ranking values; and
ranking the determined frequency of occurrences of a plurality of different failures in ranked frequency of occurrence values.

4. The method of claim 3 further comprising the step of:
determining a preliminary risk assessment of each failure as a product of the ranked severity value and the selected ranked frequency of occurrence value.

5. The method of claim 4 further comprising the step of:
comparing the preliminary risk assessment with a threshold to determine high risk assessments.

6. The method of claim 5 further comprising the step of:
determining the root cause of detected product failures for product failures having a preliminary risk assessment at least equal to a threshold.

7. The method of claim 1 further comprising:
assigning a severity rank value to the each failure effect; and
assigning a rank value to the determined frequency of occurrence of each failure effect.

8. The method of claim 1 further comprising the step of:
verifying the corrective action.

9. The method of claim 8 wherein the step of verifying the corrective action comprises the step of:
ranking a validation of a failure corrective action based on at least one of the type of validation test, the sample size and the test time.

10. The method of claim 9 further comprising the step of:
determining a final risk assessment for each corrective action equal to the product of the determined severity value, the determined frequency of occurrence value and the determined failure correction validation value.

11. The method of claim 10 further comprising the step of:
comparing the final risk assessment value with a threshold to determine failures requiring corrective action.

12. The method of claim 1 wherein the step of collecting failing product performance data comprises the step of:
forming a plurality of selectable databases containing product performance data for at least two of field performance, product change request, manufacturing performance, validation performance, prototype and pilot build inspection, measurement system performance, simulation, supplier development performance, process control, production process capability performance, manufacturing preventive maintenance, engineering development test performance, lessons learned, engineering calculations, dimensional tolerance stack-up analysis, internal/external part interface analysis, new customer requirement, supplier requirement, cost improvement, drawing change and tool wear.

13. The method of claim 12 further comprising the step of:
forming summary statistics of product performance failures for each selected product performance data database.

14. The method of claim 1 further comprising the step of:
determining the cost of quality assessment.

15. The method of claim 14 wherein the step of determining the cost of quality assessment comprises the step of:
determining the total cost of quality assessment by the sum of prevention costs, appraisal costs and failure costs.

16. A method of determining product performance comprising the steps of:
collecting product performance data;
determining the failure mode of detected product failures;
determining probability of occurrence of each detected failure;
ranking the probabilities of occurrence of each failure to obtain a occurrence value;
determining the severity of effects of each failure;
ranking the severity effects of each failure to obtain a ranked severity effect value; and
determining a preliminary risk assessment of each failure as a product of the ranked severity value and the ranked frequency of occurrence value.

17. The method of claim 16 further comprising:
comparing the preliminary risk assessment with a threshold to determine high risk assessments.

18. The method of claim 17 further comprising the step of:
determining the root cause of detected product failures for product failures having a preliminary risk assessment at least equal to a threshold.

19. The method of claim 18 further comprising the step of:
developing a corrective action to the determined root cause of the detected product failure; and
verifying the corrective action.

20. The method of claim 19 wherein the step of verifying the corrective action comprises the step of:
ranking a validation of a failure corrective action based on at least one of the type of validation test, the sample size and the test time.

21. The method of claim 20 further comprising the step of:
determining a final risk assessment for each corrective action equal to the product of the determined severity value, the determined frequency of occurrence value and the determined failure correction validation value.

22. The method of claim 21 further comprising the step of:
comparing the final risk assessment value with a threshold to determine failures requiring corrective action.

23. An apparatus for determining product performance comprising:
means for collecting product performance data;
means for determining the failure mode of detected product failures;
means for determining probability of occurrence of each detected failure;
means for ranking the probabilities of occurrence of each failure to obtain a occurrence value;
means for determining the severity of effects of each failure;
means for ranking the severity effects of each failure to obtain a ranked severity effect value; and
means for determining a preliminary risk assessment of each failure as a product of the ranked severity value and the ranked frequency of occurrence value.

24. The apparatus of claim 23 further comprising:
means for comparing the preliminary risk assessment with a threshold to determine high risk assessments.

25. The apparatus of claim 24 further comprising the step of:
means determining the root cause of detected product failures for product failures having a preliminary risk assessment at least equal to a threshold.

26. The apparatus of claim 25 further comprising the step of:
means for developing a corrective action to the determined root cause of the detected product failure; and
means for verifying the corrective action.

27. The apparatus of claim 26 wherein the step of verifying the corrective action comprises the step of:
means for ranking a validation of a failure corrective action based on at least one of the type of validation test, the sample size and the test time.

28. The apparatus of claim 27 further comprising the step of:
means for determining a final risk assessment for each corrective action equal to the product of the determined severity value, the determined frequency of occurrence value and the determined failure correction validation value.

29. The apparatus of claim 28 further comprising the step of:
comparing the final risk assessment value with a threshold to determine failures requiring corrective action.

30. The method of claim 16 wherein the step of comparing the preliminary risk assessment with a threshold comprises the steps of:
defining the threshold as a severity value at least equal to one ranked severity value; and
comparing the final risk assessment value with the threshold to determine failures requiring corrective action.

31. The method of claim 16 wherein the step of comparing the preliminary risk assessment with a threshold further comprises the step of:
defining the threshold as a customer override input.
